(19) United States
(12) Patent Application Publication
(10) Pub. No.: US 2014/0337181 A1
(43) Pub. Date: Nov. 13, 2014

(54) COLLECTIVE ORDER FULFILLMENT

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(21) Appl. No.: 13/893,059

(22) Filed: May 13, 2013

(51) Int. Cl. G06Q 30/06

(52) U.S. Cl. CPC G06Q 30/0635
USPC 705/26.81

(57) ABSTRACT

In embodiments, a buyer may place a purchase order, e.g., to a collective fulfillment computing platform, for a quantity of a product to be produced. In various embodiments, the purchase order may include one or more criteria for fulfillment of the purchase order. In various embodiments, notification of the purchase order may be transmitted, e.g., by the platform, to a plurality of potential suppliers of the product. In various embodiments, at least some of the plurality of potential suppliers may place bids to fulfill at least portions of the purchase order. In various embodiments, the platform may be configured to automatically apportion at least an initial payment for the purchase order among the bidding suppliers based at least in part on profiles associated with the first plurality of potential suppliers and the one or more criteria for collective fulfillment of the purchase order.

### BACKGROUND

Creation or manufacture of some products may require substantial investment of resources such as time and/or capital. In some instances, demand for the product at the onset of creation or manufacture may not match demand for the product at completion. For instance, a farmer may not know at the time of planting what demand for a particular crop will be several months later when it comes time to harvest. The farmer takes a substantial risk that at harvest time, demand will have declined. In some instance, demand may become so low the farmer may be unable to turn a profit, or even recoup the farmer's investment. The same may be true for other products that require a relatively long period of time and/or substantial financial investment to create or manufacture.

In a reverse auction, sellers/suppliers/manufacturers know ahead of time that a buyer desires a particular product or service. They compete to obtain that business from the buyer, e.g., by undercutting prices offered by others. However, there is typically a one-to-one relationship between the product or service desired by the buyer and the seller/supplier/manufacturer that ultimately provides it. This model does little to mitigate the risk taken by a supplier of relatively large quantities of a product, such as a farmer or manufacturer, that the demand for their product will decline during creation or manufacture of the product.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates example components that together may facilitate bidding for participation in collective fulfillment of an order, as well as tracking the order's collective fulfillment, in accordance with various embodiments.

FIG. 2 illustrates an example exchange between a buyer, a platform and a plurality of suppliers, in accordance with various embodiments.

FIG. 3 illustrates an example method that may be implemented by a computing device, in accordance with various embodiments.

FIG. 4 illustrates an example computing environment suitable for practicing selected aspects of the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

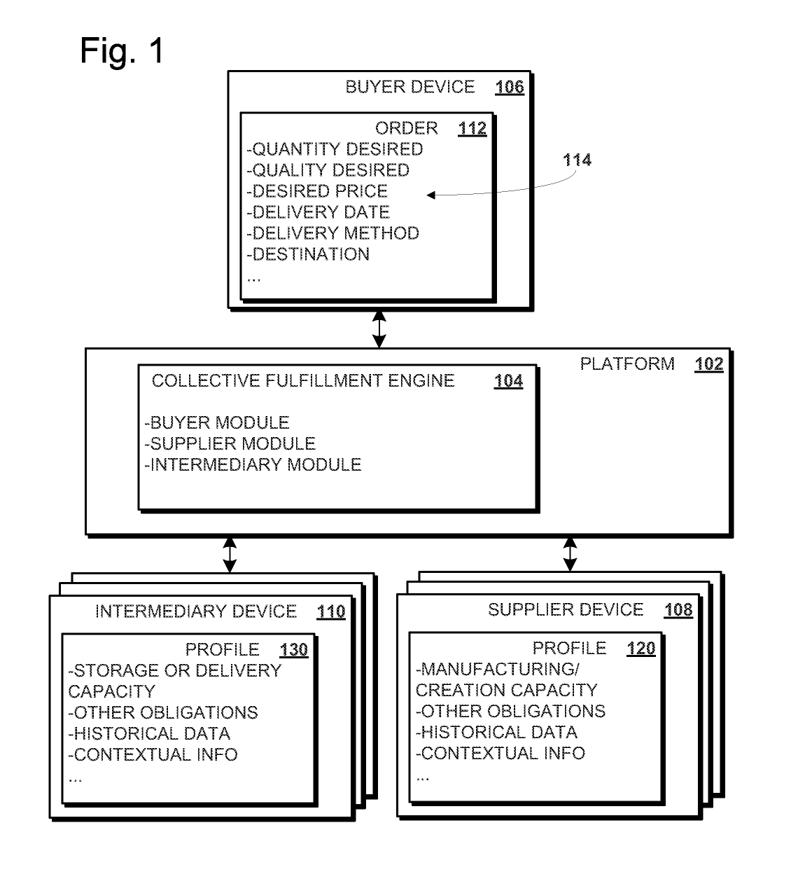

Referring now to FIG. 1, a computing platform 102, configured with applicable portions of the present disclosure, may include a collective fulfillment engine 104. Collective fulfillment engine 104 may include a buyer module configured to act as a liaison with a buyer device 106 (also referred to simply as “buyers”), a supplier module configure to act as a liaison with one or more supplier devices 108 (also referred to simply as “suppliers”), and an intermediary module configure to act as a liaison with one or more intermediary devices 110 (also referred to simply as “intermediaries”). The buyer, supplier and/or intermediary modules may be coupled with each other, and may be constituted with any combination of hardware and/or software, to be described more fully below.

In various embodiments, buyer device 106 may be usable by a buyer entity (not shown) to place a purchase order 112 (hereinafter simply an “order”) for a product or service. In various embodiments, order 112 may be generated by a buyer at buyer device 106 using a user interface (not shown). In various embodiments, order 112 may be transmitted to platform 102 over one or more computer networks (not shown), such as one or more local area networks (“LANs”), or one or more wide area networks (“WANs”) such as the Internet.

Order 112 may include various criteria 114 for fulfilling the order. In various embodiments, criteria 114 may include, but are not limited to, a quantity and/or quality of product desired, a desired price (e.g., per unit, in bulk, etc.), a desired delivery date (which may be more granular than a day, such as a desired hour, etc.), a desired delivery method (e.g., via airplane, train, truck, ship, barge, refrigerated container, etc.), one or more desired delivery destinations, and so forth.

The products and services that may be ordered using buyer device 106 may vary. In some embodiments, the product may be one that requires significant time to create or otherwise manufacture. For example, the product may be a crop, including but not limited to produce such as fruits and vegetables, or other crops used for various purposes. The buyer may be any entity that collects crops for distribution to another entity, such as a distributor that procures fruits and vegetables for retailers such as restaurants or grocery stores.

In other embodiments, the product may be a manufactured good. In such case, the buyer may be any entity that procures quantities of that manufactured good for distribution to other entities (e.g., retailers, entities that use those manufactured goods, etc.). In yet other embodiments, the product may be one or more health profiles associated with one or more individuals. In such case, the buyer may be any entity that is interested in acquiring those individuals, e.g., as patients and/or customers. For example, the buyer may be one or more health care providers (e.g., doctor's offices, hospitals, dentists, chiropractors, etc.), one or more insurance companies, or any combination thereof.

Using systems and techniques described herein, a buyer may be able to place order 112, e.g., using buyer device 106, for a quantity of products such as crops, manufactured goods or health profiles, prior to creation, manufacture or assembly of those products. In various embodiments, the buyer may contemporaneously supply at least an initial payment for the product. In various embodiments, collective fulfillment engine 104 may be configured to facilitate automatic apportionment of the at least initial payment among suppliers, as will be described further below. In some embodiments, collective fulfillment engine 104 may be configured to directly facilitate payment by buyer, e.g., by confirming a wire transfer or by accepting and/or apportioning electric payment.

A supplier 108 may no longer need to blindly grow crops, manufacture goods, or invest in medical technologies/training for treatment of particular ailments, in the hope that there will be demand at the end. Instead, buyers effectively signal prospective demand by placing the order for a quantity of product. Suppliers may then participate in satisfaction of that demand by bidding to fulfill portions of that order. This model may mitigate the risk of a supplier proceeding with creation, manufacture or assembly of the product without knowing what the demand will be at the end. Automatic apportionment among suppliers of at least an initial payment from the buyer may also enable suppliers to begin creating the product without taking out loans—or at least enable them to take out smaller loans—in order to purchase materials (e.g., seeds, fertilizer) necessary to create the product.

Suppliers 108 may be computing devices used by supplier entities (not shown) to interact with platform 102, e.g., over one or more LANs or WANs. In embodiments where the ordered product is a crop or produce, suppliers 108 may be computing devices associated with farmers, or groups of farmers organized into cooperatives (“co-ops”). In embodiments where the ordered product is a manufactured good, suppliers 108 may be computing devices associated with manufacturers. In embodiments where the ordered product is a quantity of health profiles, suppliers 108 may be computing devices associated with entities that assemble pluralities of health profiles for sale to other entities. Each supplier 108 may include a profile 120 that includes information indicative of the supplier's capability to participate in collective fulfillment of orders, such as order 112.

Intermediaries 110 may be computing devices used by intermediary entities (not shown), such as delivery companies, carriers, storage companies, shippers, and so forth, to interact with platform 102 over one or more LANs and/or WANs. Intermediary entities may perform various logistical tasks between a supplier's creation/manufacture of the product and procurement of the product by buyer 106. In many cases, intermediaries 110 may employ one or more vessels, such as ships, trucks, cars, train cars, whole trains, barges, containers, and so forth, to transport and/or store a product. Each intermediary 110 may include a profile 130 that includes information indicative of the intermediary's capability to participate in collective fulfillment of orders, including collective fulfillment of one or more tasks associated with collective fulfillment of order 112.

In various embodiments, collective fulfillment engine 104 may be configured to receive order 112 and to notify suppliers 108 and/or intermediaries 110 of the opportunity to participate in collective fulfillment of order 112. Suppliers 108 and/or intermediaries 110 may place bids to participate in collective fulfillment of order 112. Collective fulfillment engine 104 may notify buyer 106 of the bids, individually and/or in the aggregate (e.g., as a joint fulfillment proposal). Buyer 106 may in turn notify collective fulfillment engine 104 of the buyer's acceptance of one or more of the bids, or all of the bids in the joint fulfillment proposal. Collective fulfillment engine 104 may in turn notify successfully bidding suppliers 108 and/or intermediaries 110 and/or automatically apportion payment among them. The successfully bidding suppliers/intermediaries may then begin the process of collectively fulfilling order 112. For example, if suppliers 108 are farmers and the product of order 112 is corn, the farmers may begin planting corn.

In various embodiments, collective fulfillment engine 104 may be configured to automatically apportion a payment among one or more suppliers 108 and/or intermediaries 110 suitable for collective fulfillment of order 112. In various embodiments, the apportionment may be based at least in part on profiles 120 associated with a plurality of potential suppliers 108, profiles 130 associated with a plurality of potential intermediaries 110, and/or criteria 114. For example, a supplier 108 such as farmer that has grown nothing but soy beans in the last three years, or that is experiencing extreme drought, may not be suitable to participate in fulfillment of an order for soybeans. Similarly, an intermediary 110 such as a railroad company with a history of severe delays or a lack of refrigerated cars may not be suitable for delivery of a crop with a short shelf life.

Profiles 120 associated with suppliers 108 may include various information about the suppliers' respective capabilities to meet criteria 114, which may be used, e.g., by collective fulfillment engine 104, to determine their capabilities to fulfill portions of order 112. In various embodiments, profile 120 may include a manufacturing/creation capacity. For example, a profile 120 of a farmer may include a growing capacity, which may be based on the amount of land the farmer has, what the land is capable of growing, past weather patterns, overall climate, predicted future weather patterns, and so forth. In some instances, capacity of supplier 108 may be dependent on other obligations of supplier 108. For example, a portion of the farmer's land may already be committed to growing crops to fulfill another order, which may limit the farmer's contribution to collective fulfillment of order 112.

In various embodiments, a profile 120 of a supplier 108 may include historical data about the supplier 108. For example, if a farmer has in the past been able to deliver abundant and healthy tomatoes, that may suggest the farmer has sufficient experience and capability to produce abundant and healthy tomatoes in the future. On the other hand, if the farmer has grown nothing but tomatoes for the past several years, that may suggest the farmer's land is not likely going to yield yet another crop of tomatoes without at least some intermediate crop rotation.

A profile 120 of a supplier 108 may also include contextual information associated with supplier 108. This contextual information may be obtained, e.g., in real time, from various sources, such as sensors located on one or more devices associated with supplier 108, or network resources with information pertinent to supplier 108. For example, a farmer may have a barometer and/or other equipment (not shown) coupled with supplier device 108 that may configured to provide up-to-date information about the farmer's current, recently-experienced and/or predicted future weather. Collective fulfillment engine 104 may use a supplier's contextual information to determine whether supplier 108 is currently in a position to effectively participate in collective fulfillment of order 112.

Similar to profile 120 of supplier 108, profile 130 of intermediary 110 may include various information about capabilities of intermediary 110 to meet the one or more criteria, including but not limited to its respective abilities to perform tasks or portions of tasks associated with collective fulfillment of the order. This information may be usable by collective fulfillment engine 104 to determine whether intermediary 110 is suitable to participate in collective fulfillment of order 112.

In various embodiments, profile 130 may include data about storage or delivery capacity. For instance, a carrier may have a particular number of vessels (e.g., ships, train cars, trucks, containers, etc.) available for delivery of a product during a particular timeframe. Similar to supplier 108, the capacity of intermediary 110 may be affected by other obligations. For example, if all of a carrier's refrigerated vessels are committed elsewhere at or near a desired delivery date of order 112, then intermediary 110 may not have sufficient capacity to participate in collective fulfillment of order 112.

In various embodiments, profile 130 may include historical data about intermediary 110. For instance, one carrier with a history of on-time delivery may be more suitable for participation in collective fulfillment of order 112 than another carrier with a history of chronic delay, particularly where the product to be carried has a limited shelf life. As another example, one storage intermediary with a spotty history of product spoilage may be less suitable for participation in collective fulfillment of order 112 than another storage intermediary with an exemplary history of product preservation.

In various embodiments, profile 130 may also include contextual information associated with intermediary 110. For example, vessels associated with a particular carrier may be equipped with tracking devices (e.g., GPS) that provide, in real time, the locations of those vessels. Collective fulfillment engine 104 may obtain and utilize this data to determine whether the carrier is currently in a position to be able to effectively and/or efficiently deliver units of the product. For example, if a carrier's delivery vessels are far away from any bidding supplier, then that carrier may not be suitable to transport product created or manufactured by those suppliers.

In various embodiments, collective fulfillment engine 104 may be configured to identify suitable suppliers 108 and/or intermediaries 110 for participation in collective fulfillment of order 112 at various times. In some embodiments, collective fulfillment engine 104 may be configured to identify suitable suppliers 108 and/or intermediaries 110 prior to notifying them of order 112. For example, collective fulfillment engine 104 may identify suitable suppliers 108 and/or intermediaries 110 responsive to receipt of order 112, and then notify only those identified suppliers 108 and/or intermediaries 110 of order 112, rather than broadcasting it. In other embodiments, collective fulfillment engine 104 may instead be configured to notify all potential suppliers 108 and/or intermediaries 110 (e.g., broadcast) of order 112. Collective fulfillment engine 104 may then selectively apportion at least an initial payment from buyer 106 to suitable bidding suppliers 108 and/or intermediaries 110.

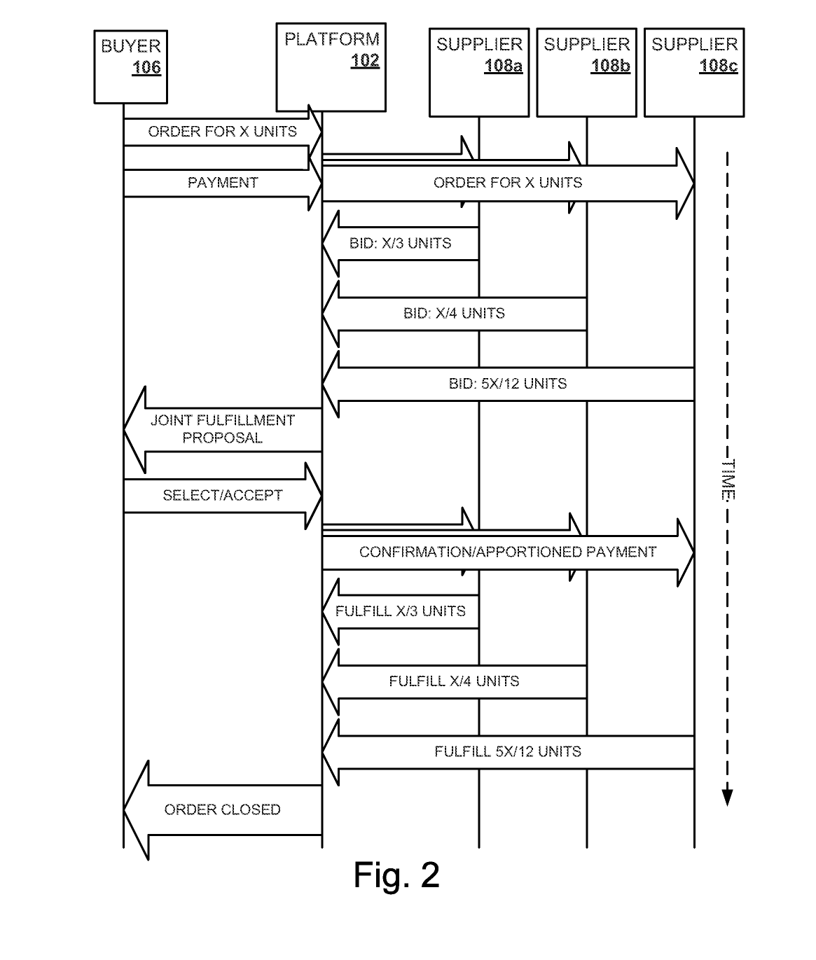

An example transaction is shown in FIG. 2. As indicated by the arrow on the right, time runs down the page. However, it should be understood time is not shown to scale. Rather, the time arrow is simply meant to demonstrate one possible sequence in which the various exchanges may occur, in accordance with various embodiments.

The exchange may begin when a buyer 106 transmits an order for x units of a particular product or service (hereinafter, simply “product”) to platform 102, e.g. to the buyer module of collective fulfillment engine 104. In some cases, buyer 106 may also transmit at least an initial payment to platform 102. However, this is not required, and in other embodiments, buyer 106 may send payment elsewhere. In such cases, platform 102, e.g., via the earlier mentioned buyer module, may merely receive notification that the payment has been submitted.

Collective fulfillment engine 104 (not shown in FIG. 2), e.g., via the earlier mentioned supplier module, may notify a first supplier 108a, second supplier 108b and third supplier 108c of the order. Suppliers 108a-c may then individually determine whether they'd like to participate in collective fulfillment of the order. While a single barrage of order notifications is shown in FIG. 2 occurring simultaneously, this is not meant to be limiting. Platform 102 may stagger notification of the order to suppliers in various ways. For example, platform 102 may notify additional suppliers (not shown) of the order at later times, e.g., when bids received from initially-notified suppliers are insufficient to collectively fulfill of the order.

Assuming suppliers 108a-c wish to participate, they may submit bids, e.g., to the earlier mentioned supplier module of collective fulfillment engine 104. For example, in FIG. 2, first supplier 108a submits a bid to fulfill a third of the units of the product ordered, second supplier 108b submits a bid to fulfill a fourth of the units of the product ordered, and third supplier 108c submits a bid to fulfill the remaining units (five twelve's) of the product ordered. As noted above, if the portions of the order bid for by the notified suppliers do not add up to total fulfillment of the order, platform 102 may notify additional suppliers of the order.

Platform 102, e.g., via the earlier-mentioned buyer module of collective fulfillment engine 104, may transmit a notification of the received bids to buyer. In various embodiments, this transmission may include an aggregation of the received bids, e.g., as a joint fulfillment proposal, and/or the bids individually. Buyer 106 may then select/accept some of the bids, or in some cases may simply accept all the bids in the aggregate (e.g., accept the joint proposal), and transmit a notification of that acceptance to platform 102.

Upon receiving selection/acceptance from buyer 106, platform 102, e.g., via the supplier module of collective fulfillment engine 104, may automatically apportion at least the initial payment received from buyer 106 among suppliers 108a-c, and/or may transmit confirmations of that acceptance to each supplier. In some embodiments, platform 102, e.g., via the earlier mentioned supplier module, may not directly apportion the payment to suppliers, but instead may direct one or more other systems (e.g., banks) to apportion the payment. In various embodiments, one supplier may not be able to view or otherwise become aware of a contribution of or payment to another supplier. Accordingly, confirmation of each supplier's accepted roll in collective fulfillment of order 112 and payment may be transmitted separately, e.g., by supplier module of collective fulfillment engine 104, to each supplier. In some embodiments, transmissions between various entities may be secured, e.g., using cryptographic techniques.

Suppliers 108a-c may then fulfill the order. Each supplier 108 may notify the supplier module of collective fulfillment engine 104, when it has completed its portion of the order. While shown fulfilling the order in a particular sequence in FIG. 2, this is not meant to be limiting. It should be understood that suppliers 108a-c may fulfill the order in any order other than the one shown, and that the time taken to collectively fulfill the order may relatively long compared to time to perform various other operations shown in FIG. 2.

Platform 102, e.g., via the supplier module of collective fulfillment engine 104, may track each supplier's respective progress, e.g., by requesting and/or receiving reports from suppliers 108a-c of their progress, including indications of when suppliers 108a-c have fulfilled their respective portions of the order. Once platform 102, e.g., via the supplier module of collective fulfillment engine 104, determines that the order has been collectively fulfilled, the buyer module of collective fulfillment engine 104, may notify buyer 106 that the order is closed. Upon closure of the order, platform 102 may no longer accept any bids for participation in collective fulfillment of order.

Collective fulfillment engine 104 may be configured to take various actions to prepare for and deal with a supplier or intermediary that cannot or will not fulfill a portion of an order (or a task associated with fulfillment of the order). For example, collective fulfillment engine 104 may populate a waiting list of alternate suppliers and/or intermediaries that will be contacted in the event that an original bidding supplier or intermediary defaults on a portion of the order. In various embodiments, these alternates may be suppliers and intermediaries that, for whatever reason, were not as suitable as the selected supplier or intermediary for fulfillment of a particular portion of an order (e.g., more expensive than the selected supplier/intermediary). However, they may be capable of fulfilling the unfulfilled portion of the order in the event that the selected supplier/intermediary is unable to do so.

In various embodiments, no suitable alternates may be available, e.g., because the delivery date is too close for the alternate supplier/intermediary to be able to effectively fulfill the unfulfilled portion of the order. In such case, collective fulfillment engine 104 may be configured to identify an insurer that is contractually obligated to underwrite fulfillment of the unfulfilled order portion by any means necessary. For instance, if a intermediary backs out last minute and no suitable alternates are available, an insurer may be called upon to hire a parcel carrier to deliver the product from one point to another, even though the parcel carrier may be much more expensive than the original selected intermediary. In various embodiments, collective fulfillment engine 104 may automatically apportion at least some of a buyer's payment to suitable insurance companies, e.g., based on profiles associated with the insurance companies (not shown but similar to profiles 120 and 130).

FIG. 2 only shows the interaction between buyer 106, platform 102 and suppliers 108a-c. However, there may be additional similar interactions (not shown) between buyer 106, platform 102 and/or intermediaries 110. In various embodiments, these additional interactions may occur at later stages, e.g., after suppliers 108 are already working to fulfill their respective portions of the order. In some cases, buyer 106 may not be directly involved with these additional interactions. For example, in some embodiments, the intermediary module of collective fulfillment engine 104 may be configured to automatically divide logistical tasks (e.g., intermediate transport/storage of product) into multiple stages. Each of these stages may be organized, e.g., by the intermediary module of collective fulfillment engine 104, as an intermediate order. In that way, a plurality of intermediaries 110 may be able to bid on participation in collective fulfillment of each intermediate order. In some embodiments, a buyer's order may be considered fulfilled only after all intermediate orders generated by platform 102 to fulfill the buyer's order are themselves collectively fulfilled.

For instance, one supplier 108 may produce more product than any individual particular carrier is capable of transporting. In such case, transport of the product produced by that supplier 108 to another location may be organized, e.g., by the intermediary module of collective fulfillment engine 104, into a transport order. Multiple carriers may be notified (in some cases, selectively) of the transport order, and may be given the opportunity to bid on participating in collective fulfillment of that transport order. In various embodiments, a single payment provided by buyer 106 may be apportioned among both suppliers 108 creating/manufacturing the ordered product and intermediaries 110 performing various tasks associated with collective fulfillment of the order.

Because intermediaries 110 may bid to fulfill portions of logistical tasks associated with collective fulfillment of an order after one or more suppliers 108 are already committed to supplying portions of the order, intermediaries 110 may further base their decision to bid on profiles 120 associated with participating suppliers 108. Additionally or alternatively, collective fulfillment engine 104 may selectively notify suitable intermediaries 110 of an order based not only on criteria 114 of order 112 and intermediary profiles 130, but also based on participating supplier profiles 120. For example, an intermediary 110 that shares a symbiotic relationship with a particular supplier 108, or is otherwise well-suited to serve that supplier 108, may stand a better chance of being identified by collective fulfillment engine 104 as suitable if that supplier 108 is already participating in collective fulfillment of an order.

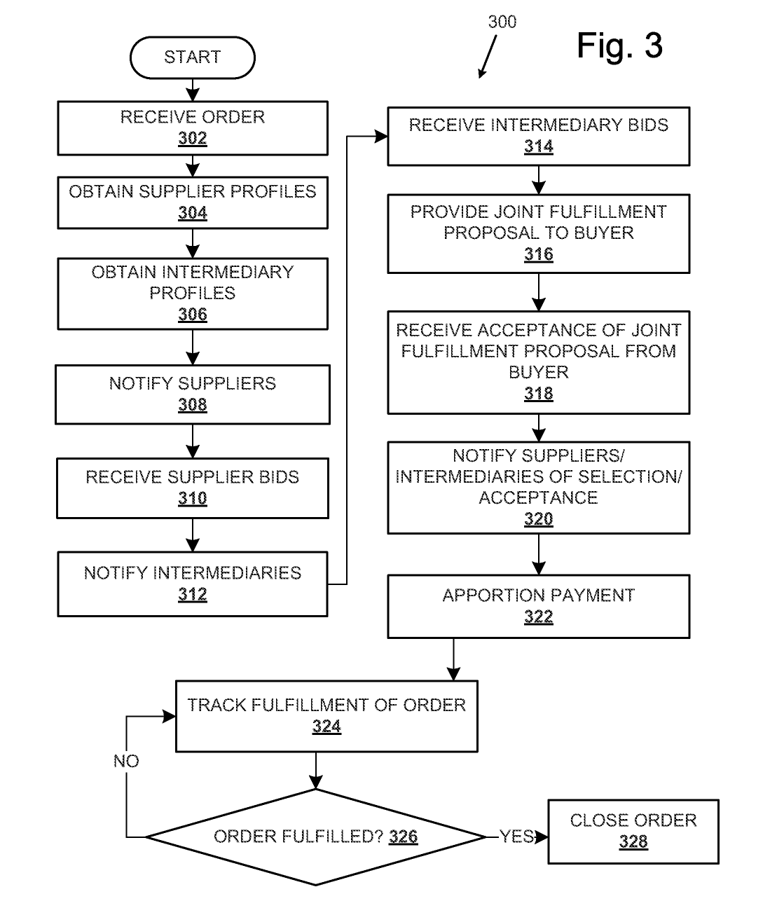

FIG. 3 depicts an example method 300 that may be implemented by collective fulfillment engine 104, in accordance with various embodiments. At operation 302, an order 112 for a quantity of a product or service may be received, e.g., by the buyer module of collective fulfillment engine 104. In various embodiments, order 112 may include one or more criteria 114 for fulfillment of the order. At operation 304, supplier profiles (e.g., 120) may be obtained, e.g., by the supplier module of collective fulfillment engine 104 from a plurality of potential suppliers. In some embodiments, collective fulfillment engine 104 may already have access to at least some supplier profiles 120 stored in memory of platform 102, or in a database. At operation 306, intermediary profiles 130 may be obtained, e.g., by intermediary module of collective fulfillment engine 104, from a plurality of intermediaries. In some embodiments, collective fulfillment engine 104 may already have access to at least some intermediary profiles 130 stored in memory of platform 102, or in a database.

At operation 308, suppliers may be notified, e.g., by the supplier module of collective fulfillment engine 104, of the order. At operation 310, bids may be received, e.g., by the supplier module of collective fulfillment engine 104, from suppliers to fulfill portions of the order.

At operation 312, intermediaries may be notified, e.g., by the intermediary module of collective fulfillment engine 104, of the order. At operation 314, bids may be received, e.g., by the intermediary module of collective fulfillment engine 104, from intermediaries to perform various tasks (e.g., delivery, storage) associated with fulfillment of portions of the order.

At operation 316, a joint fulfillment proposal may be assembled, e.g., by the buyer and/or supplier module of collective fulfillment engine 104, from the bids received at operations 312 and/or 318 and provided to buyer device 106. The joint fulfillment proposal may include individually selectable/acceptable bids and/or an aggregate of the received bids, which may be selected/accepted as a whole. At operation 318, acceptance of individual/aggregate bids may be received, e.g., by the buyer module of collective fulfillment engine 104.

At operation 320, successfully bidding suppliers/intermediaries may be notified of their selection/acceptance to participate in collective fulfillment of the order. At operation 322, the supplier module of collective fulfillment engine 104 may automatically apportion the payment provided by buyer 106 among the successfully bidding suppliers and intermediaries, e.g., based on profiles 120 and/or 130, bids received at operations 310 and 314, and/or criteria 114.

At operation 324, fulfillment of respective portions of the order by the plurality of suppliers and intermediaries may be tracked, e.g., by the supplier module of collective fulfillment engine 104. For example, the supplier and/or intermediary module of collective fulfillment engine 104 may periodically request and/or obtain, from suppliers and/or intermediaries whose bids were accepted by buyer 106, each supplier's or intermediary's progress towards fulfillment of their portion of order 112. If at operation 326 the order is not collectively fulfilled, then method 300 may proceed back to operation 324, and fulfillment may continued to be tracked, e.g., by various modules of collective fulfillment engine 104. However, if at operation 326 it is determined that the order has been collectively fulfilled (e.g., each successfully bidding supplier and intermediary has fulfilled their portion of the order), then at operation 328, the order may be closed, e.g., by collective fulfillment engine 104.

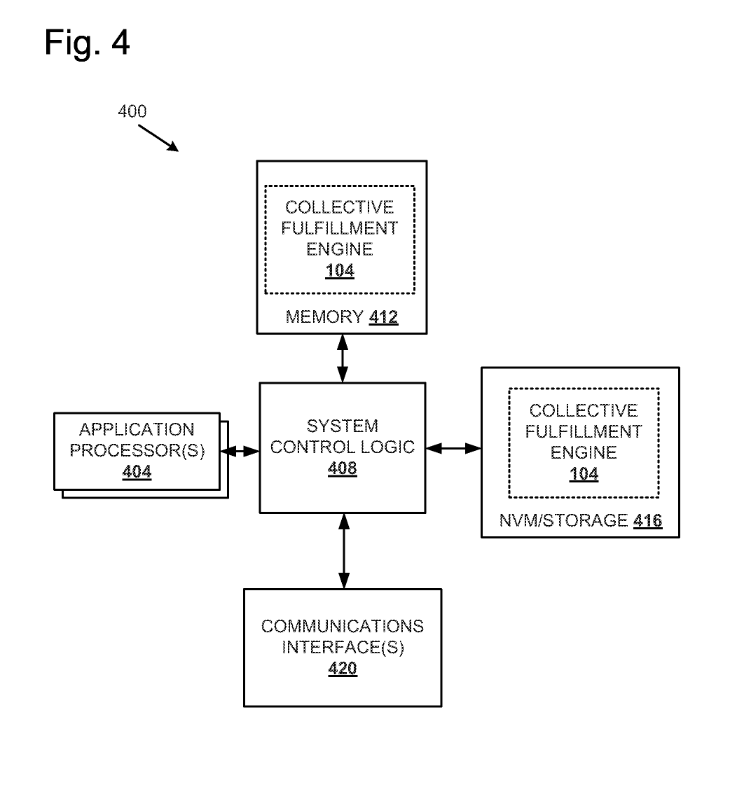

FIG. 4 illustrates, for one embodiment, an example computing device 400 suitable for practicing embodiments of the present disclosure. Computing device 400 may be used to implement various components described herein, including platform 102, buyer device 106, supplier device 108, and/or intermediary device 110.

As illustrated, example computing device 400 may include control logic 408 coupled to at least one of the processor(s) 404, system memory 412 coupled to system control logic 408, non-volatile memory (NVM)/storage 416 coupled to system control logic 408, and one or more communications interface(s) 420 coupled to system control logic 408. In various embodiments, the one or more processors 404 may be a processor core.

System control logic 408 for one embodiment may include any suitable interface controllers to provide for any suitable interface to at least one of the processor(s) 404 and/or to any suitable device or component in communication with system control logic 408.

System control logic 408 for one embodiment may include one or more memory controller(s) to provide an interface to system memory 412. System memory 412 may be used to load and store data and/or instructions, for example, for computing device 400. In one embodiment, system memory 412 may include any suitable volatile memory, such as suitable dynamic random access memory (“DRAM”), for example.

System control logic 408, in one embodiment, may include one or more input/output (“I/O”) controller(s) to provide an interface to NVM/storage 416 and communications interface(s) 420.

NVM/storage 416 may be used to store data and/or instructions, for example. NVM/storage 416 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 416 may include a storage resource physically part of a device on which the computing device 400 is installed or it may be accessible by, but not necessarily a part of, the device. For example, the NVM/storage 416 may be accessed over a network via the communications interface(s) 420.

System memory 412 and NVM/storage 416 may include, in particular, temporal and persistent copies of instructions that when executed, cause computing device 400 to operate collective fulfillment engine 104. Collective fulfillment engine 104 may include instructions that when executed by at least one of the processor(s) 404 result in the computing device 400 practicing one or more of the operations described above for method 300. In some embodiments, collective fulfillment engine 104 may additionally/alternatively be located in the system control logic 408.

Communications interface(s) 420 may provide an interface for computing device 400 to communicate over one or more network(s) and/or with any other suitable device. Communications interface(s) 420 may include any suitable hardware and/or firmware, such as a network adapter, one or more antennas, a wireless interface, and so forth. In various embodiments, communication interface(s) 420 may include an interface for computing device 400 to use NFC, Wifi Direct, optical communications (e.g., barcodes), BlueTooth or other similar technologies to communicate directly (e.g., without an intermediary) with another device.

For one embodiment, at least one of the processor(s) 404 may be packaged together with system control logic 408 and/or collective fulfillment engine 104 (in whole or in part). For one embodiment, at least one of the processor(s) 404 may be packaged together with system control logic 408 and/or collective fulfillment engine 104 (in whole or in part) to form a System in Package (“SiP”). For one embodiment, at least one of the processor(s) 404 may be integrated on the same die with system control logic 408 and/or collective fulfillment engine 104 (in whole or in part). For one embodiment, at least one of the processor(s) 404 may be integrated on the same die with system control logic 408 and/or collective fulfillment engine 104 (in whole or in part) to form a System on Chip (“SoC”).

In various implementations, computing device 400 may be a laptop, a netbook, a notebook, an ultrabook, a smartphone, a computing tablet, a personal digital assistant (“PDA”), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 400 may be any other electronic device that processes data.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A non-transitory computer-readable medium comprising instructions configured to cause a computing device, in response to execution of the instructions by the computing device, to:
receive, from a buyer device, a purchase order for a quantity of a product to be produced, wherein the purchase order includes one or more criteria for fulfillment of the purchase order;
transmit, to a plurality of potential suppliers of the product, notification of the purchase order;
receive, from at least some of the plurality of potential suppliers, bids to fulfill at least portions of the purchase order; and
automatically apportion at least an initial payment for the purchase order among the bidding suppliers based at least in part on profiles associated with the first plurality of potential suppliers and the one or more criteria for collective fulfillment of the purchase order.

2. The non-transitory computer-readable medium of claim 1, wherein the instructions, in response to execution by the computing device, further cause the computing device to:
notify each of the bidding suppliers of its expected contribution in the fulfillment of the purchase order; and
receive, from bidding suppliers, confirmation of participation.

3. The non-transitory computer-readable medium of claim 2, wherein the instructions, in response to execution by the computing device, further cause the computing device to:
provide, to the buyer device, a joint fulfillment proposal assembled from bids received from the bidding suppliers; and
receive, from the buyer device, acceptance of the joint fulfillment proposal.

4. The non-transitory computer-readable medium of claim 1, wherein the instructions, in response to execution by the computing device, further cause the computing device to:
track fulfillment of respective portions of the purchase order by bidding suppliers; and
close the purchase order responsive to a determination that an entirety of the purchase order has been collectively fulfilled by the bidding suppliers.

5. The non-transitory computer-readable medium of claim 4, wherein the instructions, in response to execution by the computing device, further cause the computing device to identify, from a waiting list, an alternate supplier to fulfill an unfulfilled portion of the purchase order responsive to a determination that a bidding supplier cannot fulfill the unfulfilled portion of the purchase order.

6. The non-transitory computer-readable medium of claim 4, wherein the instructions, in response to execution by the computing device, further cause the computing device to identify an insurer to finance fulfillment of an unfulfilled portion of the purchase order responsive to a determination that a bidding supplier cannot fulfill the unfulfilled portion of the purchase order.

7. The non-transitory computer-readable medium of claim 1, wherein the profiles of the plurality of potential suppliers include respective capabilities of the plurality of potential suppliers to meet the one or more criteria.

8. The non-transitory computer-readable medium of claim 7, wherein the respective capabilities are determined based at least in part on historical capabilities of the plurality of potential suppliers.

9. The non-transitory computer-readable medium of claim 7, wherein the respective capabilities are determined based at least in part on real-time contextual information associated with the plurality of potential suppliers.

10. The non-transitory computer-readable medium of claim 7, wherein the respective capabilities are determined based at least in part on other obligations of the plurality of potential suppliers.

11. The non-transitory computer-readable medium of claim 1, wherein the instructions, in response to execution by the computing device, further cause the computing device to obtain and store at least some of the profiles prior to receipt of the purchase order.

12. The non-transitory computer-readable medium of claim 1, wherein the instructions, in response to execution by the computing device, further cause the computing device to obtain at least some of the profiles after receipt of the purchase order.

13. The non-transitory computer-readable medium of claim 1, wherein the product includes a crop.

14. The non-transitory computer-readable medium of claim 1, wherein the product includes a manufactured product.

15. The non-transitory computer-readable medium of claim 1, wherein the product includes one or more patient health profiles associated with one or more patients, and the buyer is a health care provider and/or an insurance company.

16. The non-transitory computer-readable medium of claim 1, wherein the one or more criteria includes quality of the product.

17. The non-transitory computer-readable medium of claim 1, wherein the one or more criteria includes a desired price of the product.

18. The non-transitory computer-readable medium of claim 1, wherein the one or more criteria includes a delivery date and/or delivery location of the product.

19. The non-transitory computer-readable medium of claim 1, wherein the one or more criteria includes a delivery method of the product.

20. The non-transitory computer-readable medium of claim 1, wherein the instructions, in response to execution by the computing device, further cause the computing device to:
transmit, to a plurality of potential intermediaries, notification of the purchase order;
receive, from at least some of the plurality of potential intermediaries, bids to fulfill at least portions of a task associated with collective fulfillment of the purchase order; and
automatically apportion at least a portion of the initial payment for the purchase order among the bidding intermediaries based at least in part on profiles associated with the plurality of intermediaries and the one or more criteria for collective fulfillment of the purchase order.

21. The non-transitory computer-readable medium of claim 20, wherein the task associated with collective fulfillment of the purchase order is delivery and/or storage of units of the product.

22. A computer-implemented method, comprising:
receiving, by a computing device from a buyer device, a purchase order for a quantity of a product to be produced, wherein the purchase order includes one or more criteria for fulfillment of the purchase order;
transmitting, by the computing device to a plurality of potential suppliers of the product, notification of the purchase order;
receiving, by a computing device from at least some of the plurality of potential suppliers, bids to fulfill at least portions of the purchase order; and
automatically apportioning, by the computing device, at least an initial payment for the purchase order among the bidding suppliers based at least in part on profiles associated with the first plurality of potential suppliers and the one or more criteria for collective fulfillment of the purchase order.

23. The computer-implemented method of claim 22, further comprising:
notifying, by the computing device, each of the bidding suppliers of its expected contribution in the fulfillment of the purchase order; and
receiving, by the computing device from bidding suppliers, confirmation of participation.

24. The computer-implemented method of claim 23, further comprising:
providing, by the computing device to the buyer device, a joint fulfillment proposal assembled from bids received from the bidding suppliers; and
receiving, by the computing device from the buyer device, acceptance of the joint fulfillment proposal.

25. The computer-implemented method of claim 22, further comprising:
tracking, by the computing device, fulfillment of respective portions of the purchase order by bidding suppliers; and
closing, by the computing device, the purchase order responsive to a determination that an entirety of the purchase order has been collectively fulfilled by the bidding suppliers.

26. An apparatus, comprising:
one or more computer processors; and
a collective fulfillment engine coupled to the one or more computer processors and comprising:
a buyer module configured to receive, from a buyer device, a purchase order for a quantity of a product to be produced, wherein the purchase order includes one or more criteria for fulfillment of the purchase order; and
a supplier module configured to:
transmit, to a plurality of potential suppliers of the product, notification of the purchase order;
receive, from at least some of the plurality of potential suppliers, bids to fulfill at least portions of the purchase order; and
automatically apportion at least an initial payment for the purchase order among the bidding suppliers based at least in part on profiles associated with the first plurality of potential suppliers and the one or more criteria for collective fulfillment of the purchase order.

27. The apparatus of claim 26, wherein the profiles of the plurality of potential suppliers include respective capabilities of the plurality of suppliers to meet the one or more criteria.

28. The apparatus of claim 27, wherein the respective capabilities are determined based at least in part on historical capabilities of the plurality of potential suppliers, real-time contextual information associated with the plurality of potential suppliers, and/or other obligations of the plurality of potential suppliers.

29. The apparatus of claim 26, further comprising memory coupled to the one or more computer processors and configured to store at least some of the profiles prior to receipt of the purchase order.

30. The apparatus of claim 26, wherein the one or more criteria includes quality of the product, a desired price of the product, a delivery date and/or delivery location of the product, and/or a delivery method of the product.

31. The apparatus of claim 26, further comprising an intermediary module configured to:
transmit, to a plurality of potential intermediaries, notification of the purchase order;
receive, from at least some of the plurality of potential intermediaries, bids to fulfill at least portions of a task associated with collective fulfillment of the purchase order; and
automatically apportion at least a portion of the initial payment for the purchase order among the bidding intermediaries based at least in part on profiles associated with the plurality of intermediaries and the one or more criteria for collective fulfillment of the purchase order.
to fulfill an unfulfilled portion of the purchase order responsive to a determination that a bidding supplier cannot fulfill the unfulfilled portion of the purchase order. to fulfill an unfulfilled portion of the purchase order responsive to a determination that a bidding supplier cannot fulfill the unfulfilled portion of the purchase order.
